(19) United States
(12) Patent Application Publication
(10) Pub. No.: US 2007/0195816 A1
(43) Pub. Date: Aug. 23, 2007

(54) Communication device

(75) Inventor: Yoshifumi Tanimoto, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/705,426

(22) Filed: Feb. 13, 2007

(30) Foreign Application Priority Data
Feb. 17, 2006 (JP) 2006-040783

(51) Int. Cl. H04J 3/22

(52) U.S. Cl. 370/465; 370/401

(57) ABSTRACT

A communication device can transmit only types of data required by a receiving side, and change the type of the data during transmission. A transmitting device and a receiving device establish a communication connection via a data exchange network and perform communication. For example, when transferring sound data and moving image data collectively by MPEG-4 etc., the receiving device can request the transmitting device to transfer only the sound data or only the moving image data. At this time, the communication connection is terminated and a new communication connection is established, and if the required data is only the sound data, the data is transferred by ITU-T G.711, and if the required data is only the moving image data, the data is transferred by MPEG-2.

### BACKGROUND OF THE INVENTION

1. Field of the Invention

The present invention relates to a communication system which transmits video, sound and the like in real time.

2. Description of the Related Art

Accompanying recent development of a network technology, video, sound and the like are transmitted in real time via a data exchange network such as the Internet. Such transmission technology is used in a teleconference system etc.

For example, in a teleconference system using the Internet, a multipoint connection unit, which mixes and distributes video data and sound data from a plurality of terminals, is provided so that the same video and sound can be received at multiple places. In a well-known technique, after automatically switching the video data and the sound data and mixing each of the sound data according to sound level from each of the terminals, the video data and the sound data are distributed to each of the terminals, and accordingly, the sound level is adjusted, and the video data and the sound data are switched smoothly.

In a conventional system, the video and the sound at each of the terminals can be switched, however, for example, the conventional system cannot selectively receive only the video or only the sound. In other words, even when only the sound is required to be stored, the video and the sound are received first, and then only the sound is extracted from the received video and sound and stored. Consequently, when unnecessary data is received, a burden increases on a network as a transmission path and on a terminal that performs receiving processing.

### SUMMARY OF THE INVENTION

In order to overcome the above-described problems, preferred embodiments of the present invention provide a communication device capable of transmitting only necessary type of data and changing the type of the data during transmission.

According to an aspect of the present invention, a communication device can transmit a plurality of types of data such as both moving image and sound, the moving image, and the sound. The communication device includes a communication unit, which establishes a communication connection with a receiving device via a data exchange network and performs communication, and a control unit, which transmits data via the communication unit. When changing a type of the data while the data is being transmitted to the receiving device, the control unit controls the communication unit to terminate the communication connection, establish a new communication connection, and transmit data of the changed type.

Such a change of the type of the data, and termination of the communication connection and establishment of the new communication connection accompanying such a change can be carried out upon receiving a request from the receiving device to change the type of the data to be transmitted. In addition, when the data, the data is encoded by a coding scheme according to the type of each of the data.

According to another aspect of the present invention, a communication device can transmit a plurality of types of data such as both moving image and sound, the moving image, and the sound. The communication device includes a communication unit, which establishes a communication connection with a receiving device via a data exchange network and performs communication, and a control unit, which transmits data via the communication unit. When transmitting a plurality of the types of the data, the control unit controls the communication unit to transmit the data via separate communication connections for each of the types of the data. Furthermore, the communication device includes a function for collectively transmitting the plurality of types of the data from the communication unit via a single communication connection. The receiving device can select whether to receive a plurality of the types of the data collectively or separately. In addition, when receiving from the receiving device a request for separation while collectively transmitting the plurality of types of the data using the above-described function, the communication unit is controlled to terminate the communication connection, establish a plurality of new communication connections, and separately transmit each of the types of the data.

According to another aspect of the present invention, a communication device can receive a plurality of types of data such as both moving image and sound, the moving image, and the sound. The communication device includes a communication unit, which establishes a communication connection with a transmitting device via a data exchange network and performs communication, and a control unit, which controls data reception via the communication unit. When changing the type of the data while the data is being received from the transmitting device, the control unit controls the communication unit to designate the transmitting device to change the type of the data, terminate the communication connection, and establish a new communication connection to receive data of the changed type. In order to receive a plurality of the types of the data separately while receiving the plurality of types of the data collectively, the communication unit sends a request for separation to the transmitting device, terminates the communication connection, and establishes a plurality of new communication connections to receive each of the types of the data separately.

According to another aspect of the present invention, when changing type of data while the data is being transmitted to a receiving device, a communication connection is terminated, and a new communication connection is established to transmit data of the changed type. Generally, in a data exchange network such as the Internet, different protocols are often used according to the type of the data to be transmitted. Thus, when changing the type of the data, by terminating the communication connection and establishing the new communication connection to start communication, the preferred embodiments of the present invention can solve a case in which different protocols are used according to the type of the data to be transmitted.

When a change of the type of the data to be received is required while the receiving device is receiving the data from the transmitting device, the transmitting device is designated to change the type of the data. When the transmitting device receives a request from the receiving device to change the type of the data while transmitting the data to the receiving device, the type of the data is changed, a communication protocol is terminated, and a new communication protocol is established as described above, and accordingly, the transmitting device can transmit the type of the data requested by the receiving device, and the receiving device can receive the necessary type of the data. Therefore, only the type of the data necessary for the receiving device is transmitted on the network, and the receiving device can just receive the necessary type of the data. As a result, a burden on the network and the receiving device can be effectively reduced.

Further, by transmitting a plurality of the types of the data via separate communication connections for each of the types of the data, the receiving device can easily process each of the types of the data separately. Moreover, reception of any type of the data can be easily terminated during the reception. In addition, since a method for transmitting a plurality of the types of the data collectively or a method for transmitting a plurality of the types of the data separately can be selected, the data is collectively received unless the receiving device requires receiving the data separately. Accordingly, efficiency of the transmission and the receiving processing can be improved. Furthermore, the method for transmitting a plurality of the types of the data collectively can be easily switched to the method for transmitting a plurality of the types of the data separately by terminating the communication connection and establishing a plurality of new communication connections,

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a preferred embodiment of the present invention.

FIG. 2 illustrates an example of a communication sequence in which a type of data to be transferred is changed according to a preferred embodiment of the present invention.

FIG. 3 illustrates an example of a communication sequence in which data that has been transferred collectively is separated into each data type and transferred according to a preferred embodiment of the present invention.

### DETAILED DESCRIPTION OF PREFERRED EMBODIMENTS

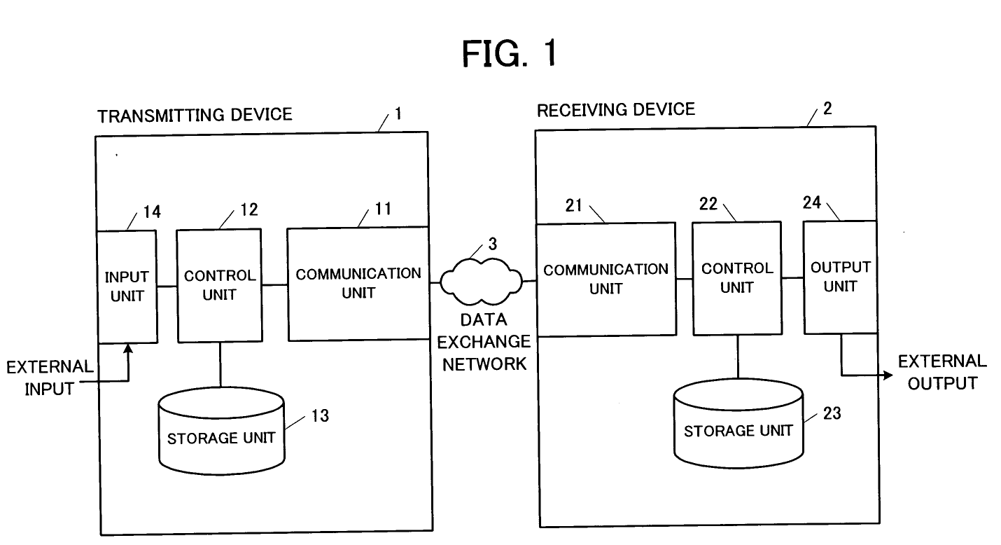

FIG. 1 is a block diagram illustrating a preferred embodiment of the present invention. In the drawing, a reference numeral 1 denotes a transmitting device, 2 denotes a receiving device, 3 denotes a data exchange network, 11 denotes a communication unit, 12 denotes a control unit, 13 denotes a storage unit, 14 denotes an input unit, 21 denotes a communication unit, 22 denotes a control unit, 23 denotes a storage unit, and 24 denotes an output unit. In an example illustrated in FIG. 1, the transmitting device 1 and the receiving device 2 are connected by the data exchange network 3 such as a Local Area Network (LAN) and the Internet so that communication can be performed.

The transmitting device 1 is a communication device capable of transmitting a plurality of types of data such as both moving image and sound, the moving image, and the sound. In the present preferred embodiment, the transmitting device 1 includes the communication unit 11, the control unit 12, the storage unit 13, and the input unit 14. The communication unit 11 establishes a communication connection on a Transmission Control Protocol (TCP) layer with the receiving device 2 via the data exchange network 3 and performs communication.

The control unit 12 transmits data stored in the storage unit 13 or data input from the input unit 14 etc. to the receiving device 2 via the communication unit 11. At this time, upon receiving a request from the receiving device 2 for the type of the data to be transmitted, the requested type of the data is transmitted from the communication unit 11. For example, when the moving image is requested as the type of the data, moving image data, which is encoded by a coding scheme suitable for the moving image such as Moving Picture Experts Group-2 (MPEG-2) etc., is transmitted from the communication unit 11 via a proper protocol. When the sound is requested as the type of the data, for example, sound data, which is encoded by a coding scheme suitable for the sound such as the International Telecommunication Unions-Telecommunications (ITU-T) G.711 etc., is transmitted from the communication unit 11 via a proper protocol. Similarly, when the moving image and the sound are requested as the types of the data, the moving image data and the sound data, which are encoded by a coding scheme suitable for the moving image and the sound such as MPEG-4 etc., are transmitted from the communication unit 11 via a proper protocol. The requested type of the data is not limited to the above-described types of the data, and the requested type of the data is transmitted via a proper protocol according to the type of the data.

While the data is being transmitted to the receiving device 2, a request for changing the type of the data to be transmitted can be received from the receiving device 2. In such a case, transmission data is changed to data to be transmitted of the changed type, and the changed data is transmitted from the communication unit 11. At this time, accompanying the request for changing the type of the data to be transmitted, the communication unit 11 terminates the communication connection, establishes a new communication connection, and transmits the data to be transmitted of the changed type via the new communication connection to the receiving device 2. As described above, when the types of the data are different, different protocols are often used to transmit such data. According to preferred embodiments of the present invention, when the type of the data to be transmitted is changed, a different communication protocol can be easily used by terminating the communication connection and establishing a new communication connection.

Further, when the above-described moving image and sound are requested as the types of the data, for example, both the moving image data and the sound data can be collectively encoded and transmitted, or separately transmitted. Moreover, the communication unit 11 can establish two communication connections with the receiving device 2, and one of the communication connections can be used to transmit the moving image data and the other communication connection can be used to transmit the sound data. In such a case, without separating the moving image data and the sound data from one another, the receiving device 2 can handle the data separately. In addition, when changing to transmission of either one of the types of the data, just one of the communication connections, which has been used for transmitting the data of the unnecessary type, is required to be terminated. However, when collectively storing the moving image data and the sound data in the receiving device 2, it is preferable to collectively transmit the encoded data and to switch between collective transmission and separate transmission.

The transmitting device 1 may designate the type of transmission data to the receiving device 2. In such a case, the control unit 12 notifies the receiving device 2 via the communication unit 11 to change the type of the data, and after receiving a response, the communication connection is terminated and the new communication connection is established as described above. Then, data of the new type can be transmitted.

The storage unit 13 can store various types of data which are required to be stored in the transmitting device 1. For example, the storage unit 13 can store data to be transmitted to the receiving device 2.

The input unit 14 includes various interfaces for input of the sound, the moving image, and the data etc., a sound input device such as a microphone, a moving image input device such as a camera, and other various data input devices and the like. The input unit 14 can input each type of the data to be transmitted to the receiving device 2. A structure without the input unit 14 can also be constructed.

The receiving device 2 can receive data from the transmitting device 1 via the data exchange network 3. In the present preferred embodiment of the present invention, the receiving device 2 includes the communication unit 21, the control unit 22, the storage unit 23, the output unit 24 etc. The communication unit 21 establishes a communication connection on a TCP layer with the transmitting device 1 via the data exchange network 3 and performs communication.

The control unit 22 receives data from the transmitting device 1 via the communication unit 21. At this time, the control unit 22 can designate a type of the data to be received to the transmitting device 1. Thus, data of the designated type can be received via a proper protocol. In addition, even when the data is being received, a designation can be made to change the type of the data. When the change of the type of the data is designated, the communication connection on the TCP layer, which has been used by the communication unit 21 for receiving the data from the transmitting device 1, is terminated, and data of the changed type is received via the new communication connection established between the receiving device 2 and the transmitting device 1.

When the moving image and the sound are designated as the types of the data, for example, MPEG-4 data, in which the moving image and the sound are integrated, is transmitted from the transmitting device 1. Accordingly, the MPEG-4 data can be received and directly stored in the storage unit 23, or the MPEG-4 data is decoded and separated, and then video output and sound output can be made from the output unit 24 or the decoded and separated MPEG-4 data can be displayed on a display device and the sound can be output from a speaker. In addition, when storing and outputting only video, the moving image can be selected as the type of the data, and when storing and outputting only the sound, the sound can be selected as the type of the data.

The storage unit 23 can store various types of data which are required to be stored in the receiving device 2. For example, the storage unit 23 can store the data received from the transmitting device 1.

The output unit 24 includes various interfaces for output of the sound and the moving image, a sound output device such as a speaker, a moving image output device such as a display, and other various data output devices and the like. The output unit 24 can output each of the types of data received from the transmitting device 1. A structure without the output unit 24 can also be constructed.

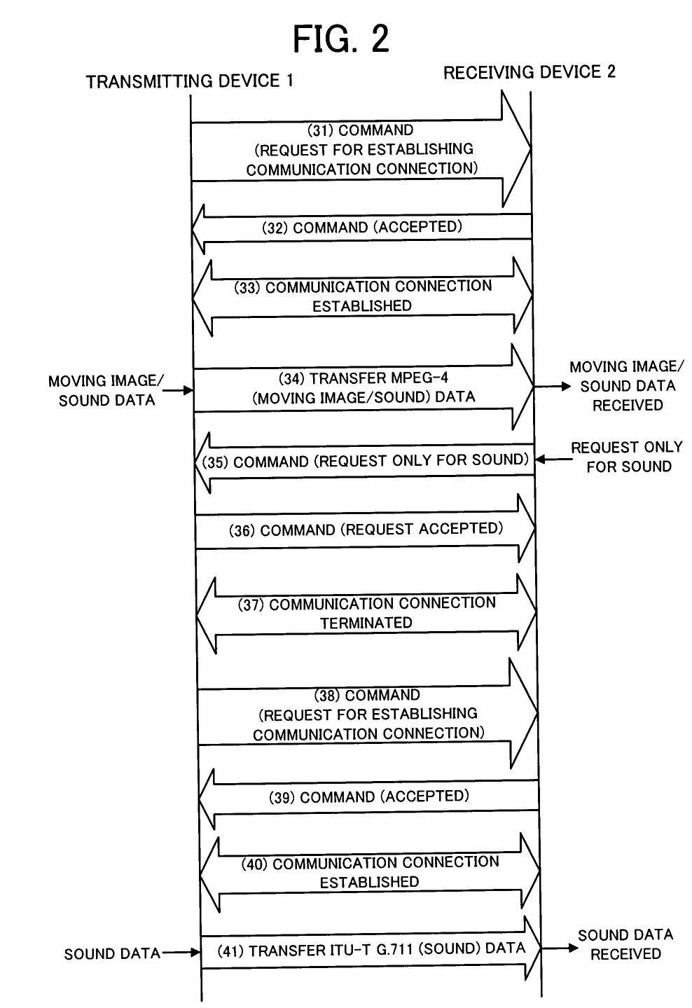

Next, a description will be made of an example of an operation according to a preferred embodiment of the present invention. FIG. 2 illustrates an example of a communication sequence in which a type of data to be transferred is changed according to the preferred embodiment of the present invention. In the present preferred embodiment, a description is made of an example in which moving image data and sound data are transferred from the transmitting device 1 to the receiving device 2, and the data during transfer is switched to only the sound data.

In the example according to the preferred embodiment of the present invention, a command requesting to start a communication connection is transmitted at (31) from the transmitting device 1 to the receiving device 2, a command informing that the command has been accepted is returned at (32) from the receiving device 2 to the transmitting device 1, and the communication connection on a TCP layer is started at (33). The receiving device 2 may request the transmitting device 1 to start the communication connection.

In the example according to the preferred embodiment of the present invention, in the started communication connection as illustrated at (34), the sound and the moving image are integrated and encoded by the transmitting device 1, and transmitted as MPEG-4 data etc. to the receiving device 2. In the receiving device 2, the integrated data can be directly stored in the storage unit 23, or the integrated data is decoded and extracted separately as the moving image data and the sound data, and then the data can be output from the output unit 24.

A description will be made of an example in which while receiving the sound data and the moving data, the receiving device 2 requires to receive only the sound data. In such a case, conventionally, the receiving device 2 continues receiving the moving image data and the sound data, and then stores or outputs only the sound data. Therefore, a burden remains on the data exchange network 3, and the transmitting device 1 and the receiving device 2 are required to process the unnecessary moving image data.

According to the preferred embodiment of the present invention, in such a case, a request only for the sound data as the type of the data is sent at (35) from the receiving device 2 to the transmitting device 1. At (36), the transmitting device 1 that has received such a request transmits a command informing that the request has been accepted to the receiving device 2, and the communication connection which has been used for communication is terminated at (37). Then, at (38), the transmitting device 1 requests the receiving device 2 to establish a communication connection. At (39), the receiving device 2 returns a command informing that the request has been accepted to the transmitting device 1, and a new communication connection is established at (40). Via the new communication connection, at (41), the transmitting device 1 encodes only the sound data, and transmits the sound data as ITU-T G.711 data, for example, to the receiving device 2. The receiving device 2 can directly store the received sound data in the storage unit 23, or can decode and output the received sound data from the output unit 24.

Thus, the receiving device 2 designates the necessary type of the data to the transmitting device 1, and can receive only the necessary type of the data. In addition, since only the data necessary for the receiving device 2 is transferred, a burden on the data exchange network 3 can be reduced, and processing at the transmitting device 1 and the receiving device 2 can also be reduced. Generally, when data formats to be transferred are different, different protocols are often used, however, by establishing another communication connection, which is different from the communication connection used to collectively transmit the moving image data and the sound data, to transmit the sound data, the most appropriate protocol for transferring the sound data can be used.

As described above, a state in which the sound data and the moving image data are collectively transferred is changed to a state in which only the sound data is transferred, however, the present invention is not limited to such an example. For example, the state in which the sound data and the moving image data are collectively transferred can be changed to a state in which only the moving image data is transferred, or similarly, the state in which only the sound data or only the moving image data is transferred can be changed to a state in which the sound data and the moving image data are collectively transferred. Moreover, transmission of only the sound data can be changed to transmission of only the moving image data and vice versa.

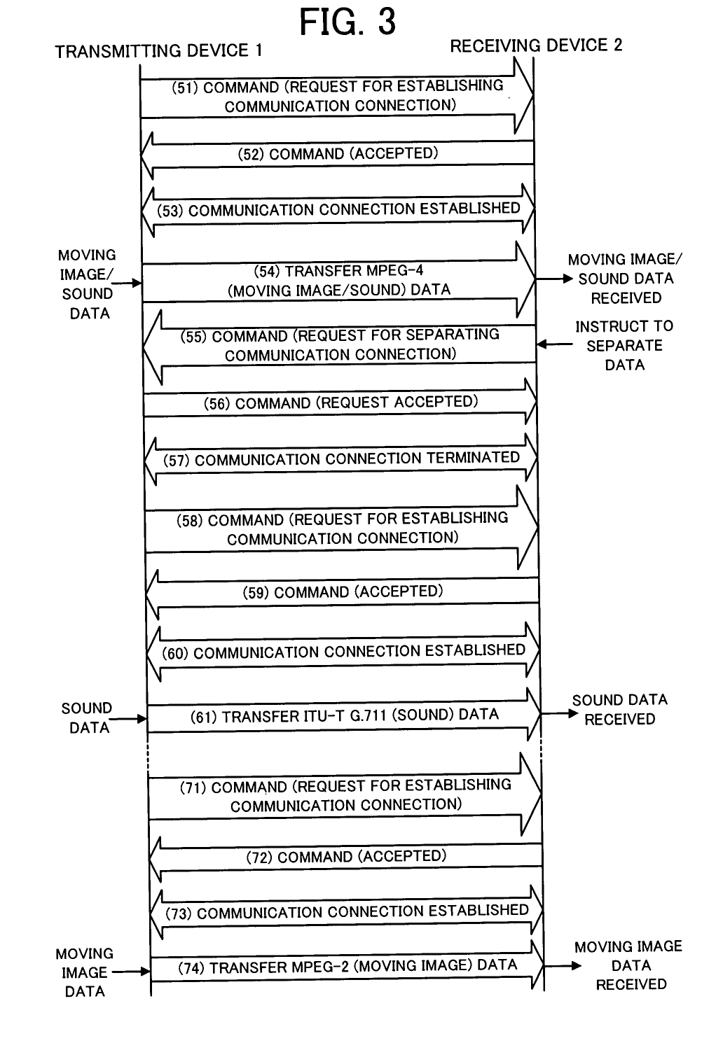

FIG. 3 illustrates an example of a communication sequence in which data that is being transferred collectively is separated into each data type and transferred according to a preferred embodiment of the present invention. In the preferred embodiment of the present invention, as a specific example, moving image data and sound data are transferred from the transmitting device 1 to the receiving device 2. First, the moving image data and the sound data are collectively transmitted, and then the moving image data and the sound data are transferred separately.

In the same manner as the example illustrated in FIG. 2, a command requesting to start a communication connection is transmitted at (51) from the transmitting device 1 to the receiving device 2, a command informing that the command has been accepted is returned at (52) from the receiving device 2 to the transmitting device 1, and the communication connection on a TCP layer is started at (53). The receiving device 2 may request the transmitting device 1 to start the communication connection.

In the started communication connection, as illustrated at (54), the sound data and the moving image data are integrated and encoded by the transmitting device 1, and transmitted as MPEG-4 data etc. to the receiving device 2. The receiving device 2 receives the transmitted data, and for example, can store the integrated data directly in the storage unit 23, or decode the integrated data and extract the moving image data and the sound data, and then output from the output unit 24.

While collectively receiving the sound data and the moving image data, when the receiving device 2 requires to receive each of the data separately, a request for separating the communication connection is sent at (55) from the receiving device 2 to the transmitting device 1. At (56), the transmitting device 1 that has received such a request transmits a command informing that the request has been accepted to the receiving device 2, and the communication connection which has been used for communication is terminated at (57). Then, at (58), the transmitting device 1 requests the receiving device 2 to establish a communication connection for transmitting the sound data. At (59), the receiving device 2 returns a command informing that the request has been accepted to the transmitting device 1. Then, a new communication connection is established at (60). At (61), the transmitting device 1 encodes only the sound data, and transmits the sound data as ITU-T G.711 data, for example, to the receiving device 2 via the new communication connection.

Further, after the communication connection is terminated at (57), a communication connection for the above-described sound data is established, and at (71), the transmitting device 1 requests the receiving device 2 to establish a communication connection for transmitting the moving image data. Then, the receiving device 2 returns a command informing that the request has been accepted to the transmitting device 1 at (72), and a new communication connection is established at (73). At (74), the transmitting device 1 encodes only the moving image data, and transmits the moving image data as MPEG-2 data, for example, to the receiving device 2 via the new communication connection.

Accordingly, communication in which the sound data and the moving image data are collectively transferred can be changed to communication in which the sound data and the moving image data are separated from one another to be transferred via separate communication connections. Therefore, without separating the moving image data and the sound data from one another at the receiving device 2, for example, each of the data can be processed separately. In addition, as described in FIG. 2 for example, when it becomes unnecessary to receive either one of the data, the reception of both of the data can be changed to the reception of only one of the data just by terminating either one of the communication connections. Either one of the communication connection for the sound data and the communication connection for the moving image data can be established first.

When the sound data and the moving image data are required to be transferred collectively while each of the data is being transferred via the separate communication connections, a request can be made by either one of the communication connections to change the sound data and the moving image data to an integrated type of the data. Accordingly, by terminating a plurality of the communication connections which have been used and establishing a new communication connection, the sound data and the moving image data can be collectively received.

In this example, the moving image data and the sound data are described as the data to be transferred, however, the present invention is not limited to the above-described example, and can be applied to various data of different types. In the above description, the receiving device 2 designated the type of the data, however, the present invention can include a function in which the transmitting device 1 can designate the type of the data and transmit the data, or either device can change the type of the data. In both of the examples, the moving image data and the sound data are collectively transferred at first, however, the present invention is not limited to such examples, and it is possible to start from transferring data of a type designated when requesting to establish a communication connection.

Furthermore, in the above-described examples, the communication connection on the TCP layer is terminated, and then the new communication connection is established, however, if the different types of the data can be transferred via the unchanged communication connection, a connection on an upper layer such as a communication session on a session layer between devices can be changed.

An example of other applications of the present invention is a teleconference device. By using the present invention in the teleconference device, it is possible to hold a teleconference by sound and video, and also the teleconference can be switched to communication only by sound such as a telephone or communication only by video. In addition, when storing contents of the teleconference, the sound and the video can be collectively stored, or only the sound or only the video can be recorded, or the sound and the video can be respectively stored.

While the present invention has been described for preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A communication device comprising:
a communication unit which establishes a communication connection with a receiving device via a data exchange network and performs communication; and
a control unit which transmits data via the communication unit by controlling the communication unit to terminate the communication connection and establish a new communication connection to transmit data of a changed type when changing the type of the data while transmitting the data to the receiving device.

2. The communication device according to claim 1, wherein when receiving a request from the receiving device for changing a type of data to be transmitted while transmitting the data to the receiving device, the control unit changes the data to be transmitted to data of the changed type, and the communication unit terminates the communication connection and establishes a new communication connection.

3. The communication device according to claim 1, wherein the type of the data is either both moving image and sound, the moving image, or the sound.

4. The communication device according to claim 2, wherein the type of the data is either both moving image and sound, the moving image, or the sound.

5. The communication device according to claim 1, wherein the control unit encodes the data by a coding scheme according to a type of each of the data and transmits the data.

6. The communication device according to claim 2, wherein the control unit encodes the data by a coding scheme according to a type of each of the data and transmits the data.

7. A communication device comprising:
a communication unit which establishes a communication connection with a receiving device via a data exchange network and performs communication; and
a control unit which transmits data via the communication unit by controlling the communication unit to transmit a plurality of types of the data via separate communication connections for each of the types of the data when transmitting the plurality of types of the data.

8. The communication device according to claim 7, wherein the control unit further includes a function to transmit a plurality of the types of the data collectively from the communication unit via a single communication connection, and
the receiving device can select whether to transmit a plurality of the types of the data collectively via a single communication connection or separately via separate communication connections.

9. The communication device according to claim 7, wherein the control unit further includes a function to transmit a plurality of the types of the data collectively from the communication unit via a single communication connection, and
the control unit controls the communication unit to terminate the communication connection and establish a new communication connection to transmit each of the types of the data separately when receiving from the receiving device a request for separation while transmitting a plurality of the types of the data collectively.

10. A communication device comprising:
a communication unit which establishes a communication connection with a transmitting device via a data exchange network and performs communication, and
a control unit which controls data reception via the communication unit by controlling the communication unit to designate a transmitting device to change the type of the data, terminate the communication connection, and establish a new communication connection to receive data of the changed type when changing the type of the data while receiving the data from the transmitting device.

11. The communication device according to claim 10, wherein the control unit controls the communication unit to send a request for separation to the transmitting device, terminate the communication connection, and establish a plurality of new communication connections to separately receive a plurality of the types of the data when receiving each of the types of the data separately while receiving each of the types of the data collectively via a single communication connection.
